(19) United States
(12) Patent Application Publication
(10) Pub. No.: US 2020/0122607 A1
(43) Pub. Date: Apr. 23, 2020

(54) TRANSPORT MOVABLE BODY

(71) Applicant: TOYOTA JIDOSHA KABUSHIKI KAISHA, Toyota-shi (JP)

(72) Inventors: Tae SUGIMURA, Miyoshi-shi (JP); Hirotaka KARUBE, Toyota-shi (JP); Kazuki MATSUMOTO, Ohgaki-shi (JP); Makoto MORI, Nagakute-shi (JP); Jun KONDO, Nissin-shi (JP)

(73) Assignee: TOYOTA JIDOSHA KABUSHIKI KAISHA, Toyota-shi (JP)

(21) Appl. No.: 16/536,391

(22) Filed: Aug. 9, 2019

(30) Foreign Application Priority Data
Oct. 17, 2018 (JP) 2018-196174

(51) Int. Cl. B60N 2/02; B60T 8/172; B60N 2/50; B60W 30/02; B60N 2/005

(52) U.S. Cl. CPC B60N 2/0244; B60T 8/172; B60N 2002/0268; B60W 30/025; B60N 2/005; B60N 2/501

(57) ABSTRACT

A transport movable body for transporting an occupant includes: a seat in which the occupant is to be seated; a reception portion configured to receive road condition information generated by a precedent vehicle; and an adjustment portion configured to adjust a setting of the seat based on the road condition information received by the reception portion.

### INCORPORATION BY REFERENCE

The disclosure of Japanese Patent Application No. 2018-196174 filed on Oct. 17, 2018 including the specification, drawings and abstract is incorporated herein by reference in its entirety.

### BACKGROUND

### 1. Technical Field

The disclosure relates to a transport movable body.

### 2. Description of Related Art

In the related art, a person in bad shape such as an injured person or a sick person (hereinafter referred to as an “injured person or the like”) is safely and comfortably transferred to a hospital or the like by a vehicle. For example, Japanese Unexamined Patent Application Publication No. 2016-188053 (JP 2016-188053 A) describes a cruise controller including a controller configured to perform restriction on an engine output or the like so that the vehicle travels at less than a predetermined limited speed calculated based on road-surface related information received from a precedent vehicle.

### SUMMARY

However, in the cruise controller described in JP 2016-188053 A, although a parameter related to a running speed such as an engine output is controlled, a parameter related to a configuration inside the vehicle is not controlled at all. On that account, ride comfort for the injured person or the like is not necessarily good, and the condition of the injured person may turn worse.

In view of this, the disclosure is intended to provide a transport movable body that is improved in ride comfort for an occupant.

A transport movable body according to one aspect of the disclosure is a transport movable body for transporting an occupant. The transport movable body includes: a seat in which the occupant is to be seated; a reception portion configured to receive road condition information generated by a precedent vehicle; and an adjustment portion configured to adjust a setting of the seat based on the road condition information received by the reception portion.

In this aspect, the setting of the seat in which the occupant is to be seated is adjusted based on the road condition information, so that ride comfort for the occupant improves.

With the disclosure, it is possible to provide a transport movable body that is improved in ride comfort for an occupant.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a view illustrating a schematic configuration of a transport system 1 according to an embodiment of the disclosure;

FIG. 2 is a block diagram illustrating a schematic configuration of a vehicle 10 according to an embodiment of the disclosure;

FIG. 3 is a view illustrating a schematic configuration of a functional module of a control device 14 provided in a precedent vehicle 10a;

FIG. 4 is a view illustrating a schematic configuration of a functional module of a control device 14 provided in a transport vehicle 10b; and FIG. 5 is a view illustrating an example of an operation sequence of the transport system 1 according to the embodiment of the disclosure.

### DETAILED DESCRIPTION OF EMBODIMENTS

With reference to the drawings, the following describes a preferred embodiment of the disclosure (note that, in each figure, members having the same reference sign have the same or similar configuration).

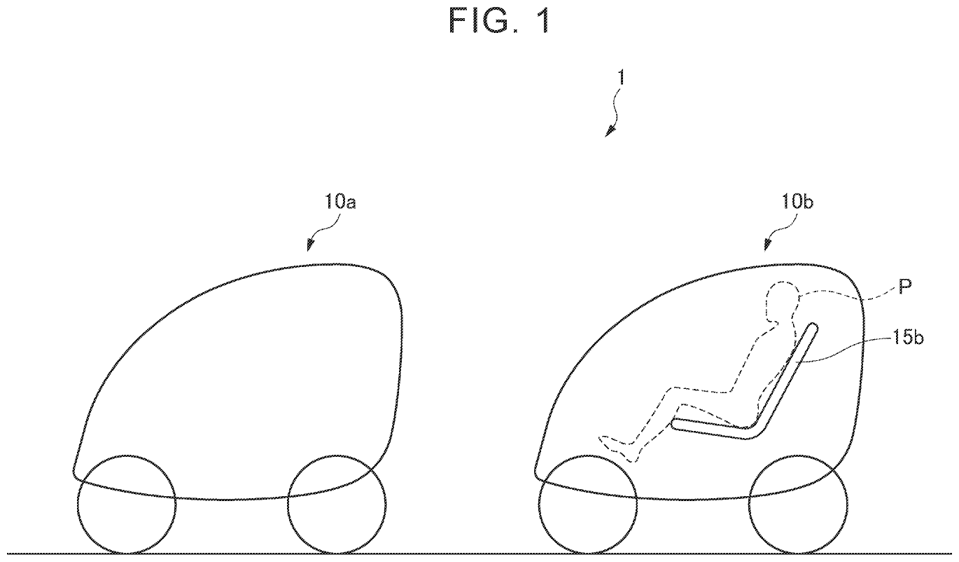

FIG. 1 is a view illustrating a schematic configuration of a transport system 1 according to an embodiment of the disclosure.

For example, the transport system 1 is a system for transporting an injured person or the like. The transport system 1 includes a precedent vehicle 10a and a transport vehicle 10b communicable with each other, for example. The precedent vehicle 10a is a vehicle (a movable body) configured to generate road condition information indicative of a road condition while the precedent vehicle 10a travels ahead of the transport vehicle 10b and to transmit the road condition information thus generated to the transport vehicle 10b that follows the precedent vehicle 10a. The transport vehicle 10b is an example of a transport movable body and follows the precedent vehicle 10a and transports an injured person P or the like. The transport vehicle 10b performs various controls related to travel based on the road condition information acquired from the precedent vehicle 10a. In the following description, the precedent vehicle 10a and the transport vehicle 10b may be collectively called a “vehicle 10.”

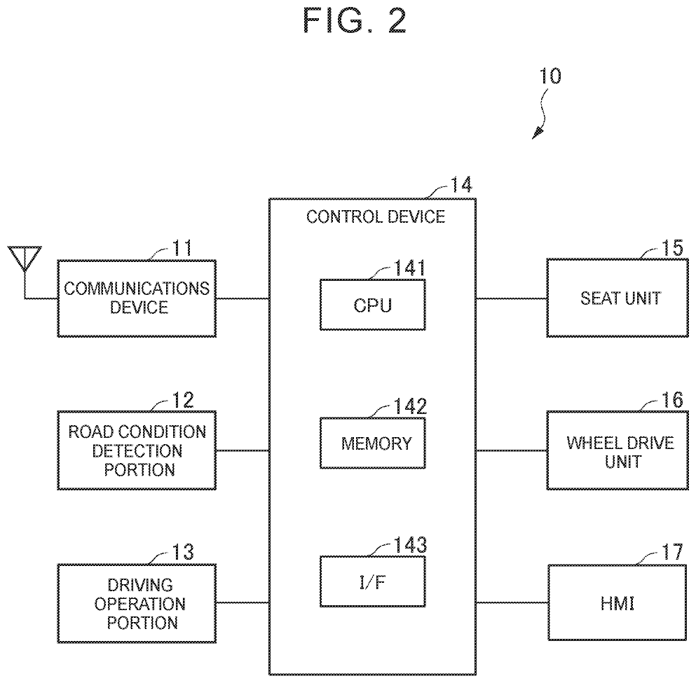

FIG. 2 is a block diagram illustrating a schematic configuration of the vehicle 10 according to the embodiment of the disclosure.

The vehicle 10 according to the embodiment of the disclosure includes a communications device 11, a road condition detection portion 12, a driving operation portion 13, a control device 14, a seat unit 15, a wheel drive unit 16, and a human machine interface (HMI) 17. The vehicle 10 can travel in either of an automatic operation mode and a manual operation mode based on a control by the control device 14.

The communications device 11 is a communications circuit unit configured to wirelessly communicate with other vehicles 10 or the like. The method or standard of the wireless communication is not limited particularly, but may be, for example, Wi-Fi, Bluetooth (registered trademark), ZigBee, NFC, RFID, and the like. The control device 14 can transmit various pieces of information to other vehicles and also receive various pieces of information from other vehicles via the communications device 11.

The road condition detection portion 12 detects a road condition and outputs a detection result to the control device 14. For example, the road condition detection portion 12 is constituted by an acceleration sensor, a vibration sensor, and the like.

The driving operation portion 13 is a unit operated by a driver to accelerate, steer, and brake the vehicle 10 in the manual operation mode and is constituted by a given constituent such as a handle, a lever, a pedal, a touch panel, a button, or the like. When the driver operates the driving operation portion 13, the driving operation portion 13 supplies a control signal for acceleration, steering, or braking corresponding to the operation to a cruise control portion 14a1, 14b1 of the control device 14. As will be described later, the cruise control portion 14a1, 14b1 of the control device 14 controls the wheel drive unit 16 based on a signal acquired from the driving operation portion 13.

The control device 14 is configured as hardware mainly based on a microcomputer constituted by: a central processing unit (CPU) 141 configured to perform a control process, a computing process, and the like; a memory 142 constituted by a read only memory (ROM) or a random access memory (RAM) in which a control program, a computing program, and the like to be performed by the CPU 141 are stored; an interface portion (I/F) 143 configured to perform output and input of a signal with respect to an external part; and so on. The CPU 141, the memory 142, and the interface portion 143 are connected to each other via data buses and the like. A function module of the control device 14 will be described later.

The seat unit 15 is one example of a seat and is a unit in which an occupant such as a driver or a passenger is to be seated. A setting such as a position or an inclination of the seat unit 15 can be adjusted by a seat unit adjustment portion 14b4 (described later).

The wheel drive unit 16 drives driving wheels provided in the vehicle 10 based on a control signal acquired from the control device 14. Note that a plurality of wheel drive units 16 may be provided so as to correspond to the number of driving wheels. For example, the wheel drive unit 16 can be constituted by a motor, a reduction gear connected to a rotating shaft of the motor in a power transmittable manner, and so on.

The HMI 17 is an interface via which information is transmitted and received between an occupant (including a driver) in the vehicle 10 and the control device 14. The HMI 17 includes, for example, a display panel configured to display image information to the occupant, a speaker for voice output, an operation button or a touch panel via which the occupant performs an input operation, and so on.

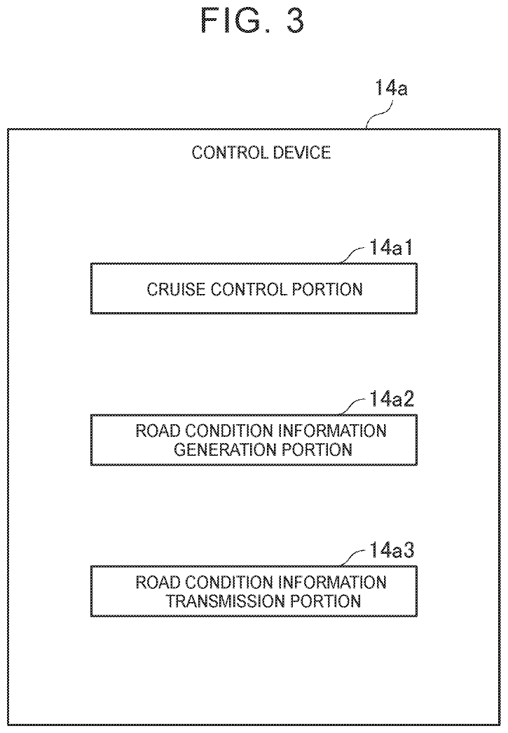

FIG. 3 is a view illustrating a schematic configuration of the functional module of the control device 14 provided in the precedent vehicle 10a.

The control device 14 provided in the precedent vehicle 10a includes the cruise control portion 14a1, a road condition information generation portion 14a2, and a road condition information transmission portion 14a3.

The cruise control portion 14a1 controls the wheel drive unit 16 based on a control signal supplied from the driving operation portion 13 in the manual operation mode. Further, the cruise control portion 14a1 controls the wheel drive unit 16 based on a set travel plan in the automatic operation mode. Note that the cruise control portion 14a1 may acquire a travel state of the transport vehicle 10b via the communications device 11 and control the wheel drive unit 16 based on the acquired travel state of the transport vehicle 10b.

The road condition information generation portion 14a2 generates road condition information indicative of a road condition based on information on the road condition supplied from the road condition detection portion 12.

The road condition information transmission portion 14a3 transmits the road condition information to the transport vehicle 10b via the communications device 11.

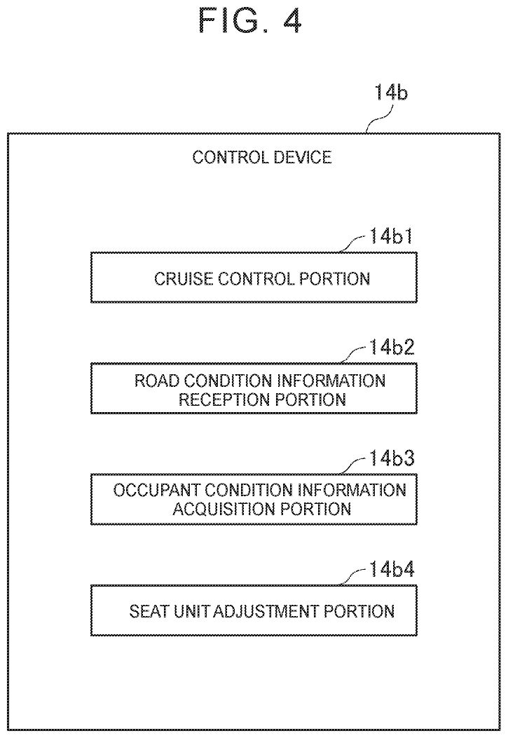

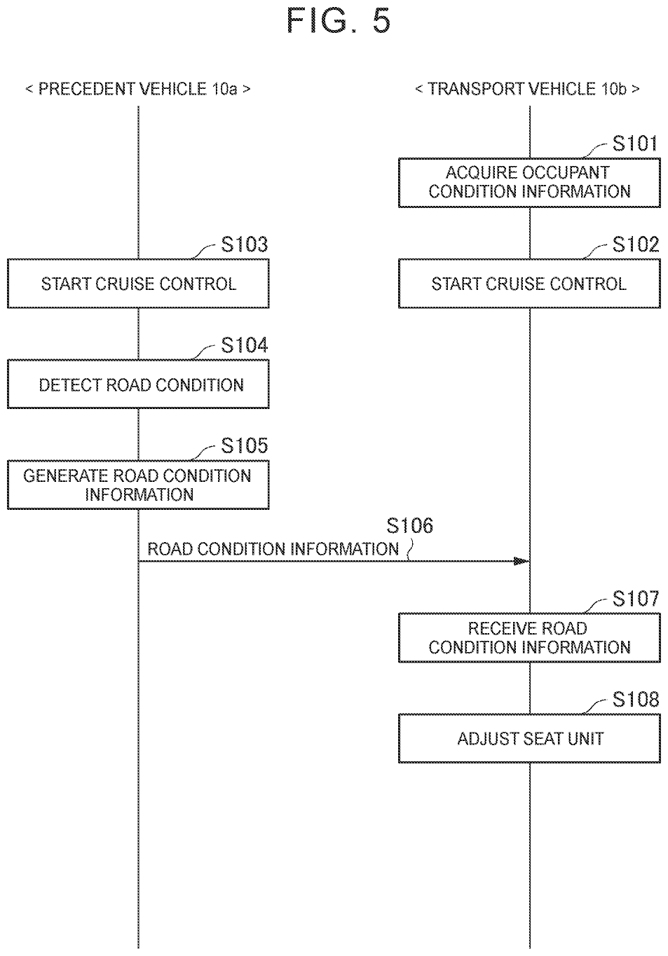

FIG. 4 is a view illustrating a schematic configuration of the functional module of the control device 14 provided in the transport vehicle 10b.

The control device 14 provided in the transport vehicle 10b includes the cruise control portion 14b1, a road condition information reception portion 14b2, an occupant condition information acquisition portion 14b3, and a seat unit adjustment portion 14b4.

The cruise control portion 14b1 controls the wheel drive unit 16 based on a control signal supplied from the driving operation portion 13 in the manual operation mode. Further, the cruise control portion 14b1 controls the wheel drive unit 16 based on a set travel plan in the automatic operation mode. Note that the cruise control portion 14b1 may acquire a travel state of the precedent vehicle 10a via the communications device 11 and control the wheel drive unit 16 based on the acquired travel state of the precedent vehicle 10a.

The road condition information reception portion 14b2 receives the road condition information from the precedent vehicle 10a via the communications device 11.

The occupant condition information acquisition portion 14b3 acquires occupant condition information indicative of a condition of an occupant. The occupant condition information acquisition portion 14b3 may acquire the occupant condition information by receiving the occupant condition information input by an operation on the HMI 17 by the occupant or the like, for example. Alternatively, the occupant condition information acquisition portion 14b3 may acquire the occupant condition information by receiving the occupant condition information from other information processors and the like (e.g., a server device) via the communications device 11. The occupant condition information may include an injured part and a degree of the injury in a case where the occupant is an injured person or may include a disease name, a medical condition, a symptom, and the like in a case where the occupant is a sick person, for example. Further, the occupant condition information may include attribute information such as age, sex, date of birth, address, and the like of the occupant or may include information on body or health, e.g., height, weight, physical condition, and the like.

The seat unit adjustment portion 14b4 is one example of an adjustment portion and adjusts the setting of the seat unit 15 based on the road condition information and/or the occupant condition information received by the road condition information reception portion 14b2.

FIG. 5 is a view illustrating an example of an operation sequence of the transport system 1 according to the embodiment of the disclosure.

First, the occupant condition information acquisition portion 14b3 of the transport vehicle 10b acquires occupant condition information (S101). In terms of how to acquire the occupant condition information, the occupant condition information may be acquired by the operation on the HMI 17 by the occupant or the like, or the occupant condition information may be acquired by receiving the occupant condition information from other information processors and the like (e.g., a server device) via the communications device 11, as described above.

Then, the cruise control portions 14a1, 14b1 of the precedent vehicle 10a and the transport vehicle 10b start cruise controls on the precedent vehicle 10a and the transport vehicle 10b (S102, 103). At this time, the cruise control portions 14a1, 14b2 control respective wheel drive units 16 based on control signals supplied from respective driving operation portions 13 in the manual operation mode. Further, the cruise control portions 14a1, 14b1 control the respective wheel drive units 16 based on respective set travel plans in the automatic operation mode.

Subsequently, the road condition detection portion 12 of the precedent vehicle 10a detects a road condition (S104). Then, the road condition information generation portion 14a2 of the precedent vehicle 10a generates road condition information indicative of the road condition based on a detection result from the road condition detection portion 12 (S105). Then, the road condition information transmission portion of the precedent vehicle 10a transmits the road condition information to the transport vehicle 10b (S106).

Subsequently, the road condition information reception portion 14b2 of the transport vehicle 10b receives the road condition information transmitted from the precedent vehicle 10a (S107). Then, the seat unit adjustment portion 14b4 of the transport vehicle 10b adjusts the setting of the seat unit 15 based on the road condition information and/or the occupant condition information thus received (S108). More specifically, for example, the seat unit adjustment portion 14b4 adjusts an inclination, a direction, a height, and the like of the seat unit 15. Further, the cruise control portion 14b1 may control the travel of the transport vehicle 10b based on the road condition information and/or the occupant condition information.

The embodiment described above is intended to facilitate understanding of the disclosure and is not intended to interpret the disclosure in a limitative manner. Each element provided in the embodiment and its arrangement, material, condition, shape, size, and the like are not limited to those described herein and can be changed appropriately.

Further, the configurations described in different embodiments can be partially replaced or combined.

What is claimed is:

1. A transport movable body for transporting an occupant, the transport movable body comprising:
a seat in which the occupant is to be seated;
a reception portion configured to receive road condition information generated by a precedent vehicle; and
an adjustment portion configured to adjust a setting of the seat based on the road condition information received by the reception portion.

2. The transport movable body according to claim 1, further comprising an acquisition portion configured acquire occupant condition information indicative of a condition of the occupant, wherein the adjustment portion adjusts the setting of the seat based on the road condition information and the occupant condition information.

3. The transport movable body according to claim 1, further comprising a cruise control portion configured to control travel of the transport movable body based on the road condition information received by the reception portion.

4. The transport movable body according to claim 1, wherein the adjustment portion adjusts at least any of an inclination, a direction, and a height of the seat based on the road condition information received by the reception portion.
